(19) United States
(12) Patent Application Publication
(10) Pub. No.: US 2015/0193595 A1
(43) Pub. Date: Jul. 9, 2015

(54) SYSTEMS AND METHODS FOR REPORTING PATIENT HEALTH PARAMETERS

(71) Applicant: IlnfoBionic, Inc., Lowell, MA (US)

(72) Inventors: Anastasia McNamara, Susequehanna, PA (US); Serban GEORGESCU, Natick, MA (US); Ravi KUPPURAJ, Andover, MA (US)

(73) Assignee: IlnfoBionic, Inc.

(21) Appl. No.: 14/591,797

(22) Filed: Jan. 7, 2015

Related U.S. Application Data
(60) Provisional application No. 61/925,129, filed on Jan. 8, 2014.

(51) Int. Cl. G06F 19/00

(52) U.S. Cl. CPC G06F 19/3487; G06F 19/3406

(57) ABSTRACT

A method for displaying health data may include receiving two or more health data sets. Each health data set may be physiological data of a patient as a function of time. The method may also include generating a display of the two or more health data sets such that a first health data set of the two more health data sets is visually aligned with a second health data set of the two or more health data sets at multiple points in time.

### CROSS-REFERENCE TO RELATED APPLICATIONS

This application claims the benefit of priority from U.S. Provisional Application No. 61/925,129, filed on Jan. 8, 2014, the entirety of which is incorporated herein by reference.

### TECHNICAL FIELD

Various embodiments of the present disclosure relate generally to displaying health data. More specifically, particular embodiments of the present disclosure relate to systems and methods for reporting data related to a patient's health to a medical practitioner.

### BACKGROUND

Remote monitoring of patients enables doctors to detect, diagnose, and/or treat heart problems, such as arrhythmias, that may produce only transient symptoms and, therefore, may not be evident when the patients visit their doctor. Health data may be collected by multiple sensors or monitors for subsequent analysis by a physician or other healthcare professional (“user”).

A “Holter” monitor is worn by a patient and collects and stores data for a period of time, typically at least 24 hours, and in some cases up to two weeks. After the data has been collected, the Holter monitor is typically brought or sent to a physician's office, laboratory, or the like, and the data is retrieved from the monitor and analyzed.

A pre-symptom (looping memory) event monitor collects and stores patient data in a “loop” memory device, wherein the event monitor constantly overwrites previously-stored data with newly-collected data. The event monitor includes a button, which the patient is instructed to actuate if the patient feels ill or otherwise detects a heart-related anomaly. In response, the event monitor continues to record data for a short period of time and then stops recording, thereby retaining data for a time period that spans the button actuation. Typically, the retained data represents a period of time that extends from a few minutes before the user actuated the button to a few minutes after the user actuated the button. The retained data may then be sent or transmitted by the patient to a physician's office or to a laboratory for analysis. Such an event monitor can facilitate analysis of patient data more proximate in time to the patient-detected anomaly. However, relying on the patient to actuate the device and then send the data can be problematic.

Some event monitors automatically detect certain arrhythmias and, in response, record electrocardiograph (ECG) data. Automatic event monitors are thought to be more sensitive, but less specific, for significant cardiac arrhythmias than manually-triggered cardiac event monitors. These devices rely on patients to send the recorded data for analysis, and there is a delay between detection of a suspected arrhythmia and transmission of the data. Some of such monitors have cellular transmission capabilities incorporated therein.

Mobile cardiovascular telemetry (MCT) refers to a technique that involves noninvasive ambulatory cardiac event monitors that are capable of continuous measurements of heart rate and rhythm over several days to weeks. MCT devices may include an automatic ECG arrhythmia detector that couples to a cellular telephone device to immediately transmit automatically detected abnormal ECG waveforms to a remote monitoring center, which can then alert a physician. Patients are also able to indicate symptoms they experience through the device should they occur during the monitoring period. Such devices may also include a memory capable of storing ECG waveform data, which is transmitted to a cellular phone for analysis, and then to the remote monitoring center whenever an event is detected by the smartphone algorithms or a symptom is indicated by the patient. Typically, memory storage for MCT devices ranges from 24 hours up to 30 days. Some MCT devices continuously send all collected ECG data to a remote monitoring center for analysis while others only send a subset of the data (e.g., detected abnormal data and reported data, etc.). MCT devices that continually send all collected ECG data typically do not perform any ECG analysis on the device level.

Regardless of how data is collected, and how much health data is collected and analyzed (locally and/or remotely), the resulting data is typically presented to physicians in long, printed reports. Such reports may be numerous, tedious to review, difficult to understand, and may inhibit physicians and other healthcare professionals from making a quick and comprehensive assessment of a patient's condition.

Thus, there remains a need for improved systems and methods for reporting and displaying health data.

### BRIEF DESCRIPTION OF THE FIGURES

The accompanying drawings, which are incorporated in and constitute a part of this specification, illustrate various exemplary embodiments and together with the description, serve to explain the principles of the disclosed embodiments.

FIG. 1 illustrates a schematic of an exemplary system and environment for collecting, processing, and reporting health data.

FIG. 2 illustrates an exemplary flow diagram of a method for collecting, processing, and reporting health data.

FIG. 3 illustrates a schematic diagram of an exemplary system for collecting health data according to an embodiment of the present disclosure.

FIG. 4A illustrates an exemplary report of health data according to an embodiment of the present disclosure.

FIG. 4B illustrates an exemplary time series graph of the report of FIG. 4A.

FIG. 5 shows another exemplary time series graph of the report of FIG. 4A.

FIG. 6 shows another exemplary display of health data in the report of FIG. 4A.

FIG. 7 shows another exemplary display of health data in the report of FIG. 4A.

### SUMMARY

In one aspect, a method for displaying health data is disclosed. The method may include receiving two or more health data sets. Each health data set may be physiological data of a patient as a function of time. The method may also include generating a display of the two or more health data sets such that a first health data set of the two more health data sets is visually aligned with a second health data set of the two or more health data sets at multiple points in time.

Additionally or alternatively, the method may include one or more of the following aspects: generating a display may include generating a display such that all health data sets of the two or more health data sets are visually aligned at all points in time; each health data set of the two or more health data sets may be displayed in a graph extending along a horizontal time axis, with the graph of each data set being stacked along a vertical axis; the two or more health data sets may include at least one of a cardiovascular parameter, a respiratory parameter, a cognitive parameter, a musculoskeletal parameter, a dermatological parameter, a vascular parameter, and a gastrointestinal parameter; the two or more health data sets may include one or more of a heart rate, an activity level, a respiration rate, a blood pressure, a blood oxygen saturation level, a blood insulin level, a pulse oximetry value, an impedance value, and a body temperature; the generated display may further include comments from at least one of a physician, a healthcare provider, and the patient; generating a display may include generating a display of the two or more health data sets for a period of time of twenty-four hours; the generated display may distinguish a period of time corresponding to day time and a period of time corresponding to night time; the generated display may include an indicator that indicates a normal range of at least one data set of the one or more data sets; and the indicator may include a bar extending parallel to a time axis.

In another aspect, a device for displaying health data of a patient is disclosed. The device may include a data storage device storing instructions for displaying health data and a processor configured to execute the instructions to perform a method. The method may comprise receiving two or more health data sets. Each health data set may be physiological data of the patient as a function of time. The method may also include generating a display of the two or more health data sets such that a first health data set of the two more health data sets is visually aligned with a second health data set of the two or more health data sets at multiple points in time.

Additionally or alternatively, the device may include the following aspects: generating a display may include generating a display such that all health data sets of the two or more health data sets are visually aligned at all points in time; each health data set of the two or more health data sets may be displayed in a graph extending along a horizontal time axis, with the graph of each data set being stacked along a vertical axis; the two or more health data sets may include one or more of a heart rate, an activity level, a respiration rate, a blood pressure, a blood oxygen saturation level, a blood insulin level, a pulse oximetry value, an impedance value, and a body temperature; the generated display may further include comments from at least one of a physician, a healthcare provider, and the patient; the generated display may include an indicator that indicates a normal range of at least one data set of the one or more data sets; the generated display may further include information received from at least one of: a physician, a healthcare provider, or the patient.

In yet another aspect, a non-transitory computer readable medium is disclosed. The computer readable medium may include instructions that when executed on a processor may cause the processor to perform operations including receiving two or more health data sets. Each health data set may be physiological data of the patient as a function of time. The operations may also include generating a display of the two or more health data sets such that a first health data set of the two more health data sets is visually aligned with a second health data set of the two or more health data sets at multiple points in time.

Additionally or alternatively, in some embodiments, the non-transitory computer readable medium may include the following aspects: generating a display may include generating a display such that all health data sets of the two or more health data sets may be visually aligned at all points in time; each health data set of the two or more health data sets may be displayed in a graph extending along a horizontal time axis, with the graph of each data set being stacked along a vertical axis.

### DETAILED DESCRIPTION

Reference will be made in detail to exemplary embodiments of the disclosure, examples of which are illustrated in the accompanying drawings. Wherever possible, the same reference numbers will be used throughout the drawings to refer to the same or like parts.

Embodiments of the present disclosure may include methods and systems for reporting health data. Various aspects of the present disclosure may be used in combination with and/or include one or more features disclosed in U.S. Pat. No. 8,478,418, issued Jul. 2, 2013, entitled “Remote Health Monitoring System” and/or U.S. Pat. No. 8,620,418, issued Dec. 31, 2013, entitled “Systems and Methods for Processing and Displaying Patient Electrocardiograph Data,” both of which are incorporated by reference herein in their entireties.

Patient health data (“health data”) may include any detected, measured, or calculated physiological data including, but not limited to, one or more cardiovascular, respiratory, cognitive, musculoskeletal, dermatological, vascular, and/or gastrointestinal parameters. For example, health data may include one or more of heart rate, activity level (e.g., physical mobility or movement), respiration rate, blood pressure (e.g., systolic and/or diastolic), blood oxygen saturation (SpO2), blood glucose or insulin level, pulse oximetry, impedance, and/or body temperature. In some embodiments, health data may also include parameters related to incapacitation of a patient, such as, for example, parameters indicative of a patient falling. In some embodiments, health data may include electrocardiography (ECG) and/or other sensor data that may be collected, processed, and displayed, for detection and/or diagnosis of arrhythmic events or conditions. In some embodiments, health data may also include cardiac safety indicators such as QT prolongation, ST elevation, etc. Any of the types of health data, methods of collecting health data, methods of processing health data, and/or methods of displaying health data disclosed in U.S. Pat. No. 8,478,418, and/or U.S. Pat. No. 8,620,418 (both incorporated by reference herein), may be used according to the present disclosure.

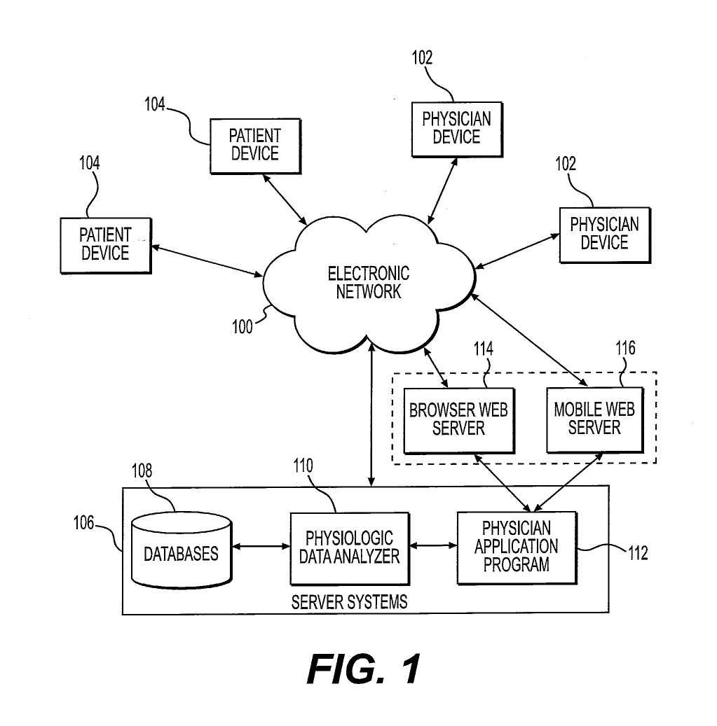

FIG. 1 shows a schematic diagram of an exemplary system and environment for collecting, processing, and displaying patient health data, such as ECG data, according to an exemplary embodiment of the present disclosure. As shown in FIG. 1, the system and environment may include a plurality of physician devices 102 and patient devices 104 disposed in communication with an electronic network 100. Electronic network 100 may include the Internet, or any other combination of wired and/or wireless electronic networks. A plurality of server systems 106, a browser web server 114, and/or a mobile web server 116 may also be disposed in communication with electronic network 100. Server systems 106 may be configured to receive physiological data from patient devices 104 over electronic network 100. Server systems 106 may include a physiological data analyzer 110, which may be configured to perform analysis of received physiological data, and a physician application program 112 that allows a physician to control parameters of the system, such as threshold values used by the data analyzer 110 in performing analyses. For example, the ECG data may be processed by the data analyzer 110 to automatically classify heartbeats using morphology and heartbeat interval features, as described by Philip de Chazal, et al., in “Automatic Classification of Heartbeats Using ECG Morphology and Heartbeat Interval Features,” IEEE Transactions on Biomedical Engineering, Vol. 51, No. 7, July, 2004, the content of which is hereby incorporated by reference herein. Further details of the exemplary system and environment shown in FIG. 1 are discussed in U.S. Provisional Application No. 61/749,052, filed Jan. 4, 2013, and U.S. Pat. No. 8,620,418 issued on Dec. 31, 2013, which are incorporated by reference herein.

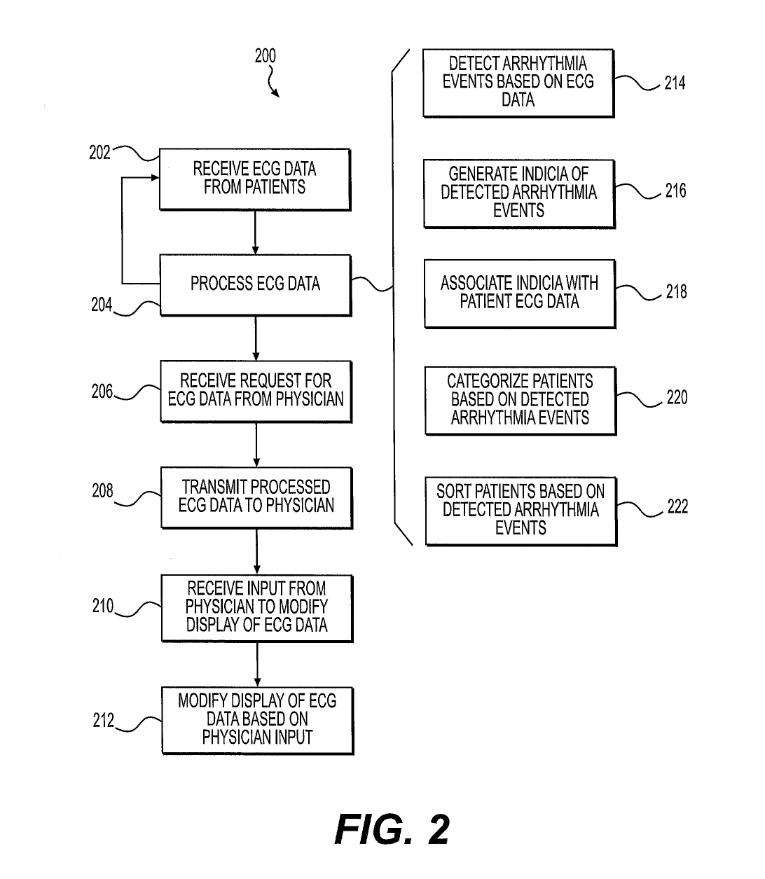

FIG. 2 shows a flow diagram of an exemplary method 200 for collecting, processing, and displaying ECG data, using the system and devices of FIG. 1. While FIG. 2 relates to ECG data and detection of arrhythmia events, any other health data and/or conditions or events may be collected, processed, and displayed as illustrated in FIG. 2. Method 200 may initially include receiving ECG data from one or more patients (step 202), processing the received ECG data (step 204), receiving a request for ECG data from a physician or a health care professional (step 206), transmitting the processed ECG data to a physician (step 208), receiving an input from a physician to modify a display of ECG data (step 210), and modifying a display of ECG data based on received user input (step 212). As shown in FIG. 2, processing the received ECG data (step 204) may include detecting arrhythmic events (step 214), generating an indicia of each detected arrhythmic event (step 216), associating the generated indicia with patient ECG data (step 218), categorizing patients based on the detected arrhythmic events (step 220), and/or sorting patients based on the detected arrhythmic events (step 222). Further details of the exemplary method shown in FIG. 2 are discussed in U.S. Pat. No. 8,798,734, issued Aug. 5, 2014, which is incorporated by reference herein.

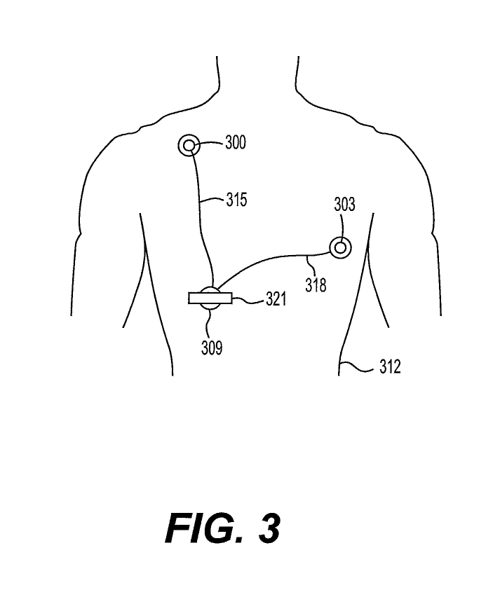

FIG. 3 shows a schematic diagram of a device, e.g., one or more physiological sensors, positioned on a patient torso for collecting patient ECG data, according to an exemplary embodiment of the present disclosure. FIG. 3 shows possible placement of sensors 300, 303, and 309 on a torso 312 of a patient. The sensors 300, 303, 309 may be connected via wires or optical cables 315, 318 or via wireless links, such as Bluetooth links. Further details of the exemplary sensory device shown in FIG. 3 are discussed in U.S. Pat. No. 8,620,418, which is incorporated by reference herein. While FIG. 3 shows sensors (e.g., electrodes) placed on the surface of the body, in some embodiments, sensors or other physiological data measurement devices may be located inside the body (e.g., implanted or coupled to medical implants inside the body). For example, a pressure sensor may measure internal pressure of a patient. In some embodiments, a single sensor may collect the health data (e.g., a single sensor configured to measure one or more physiological parameters), while in other embodiments, a plurality of sensors may be used. Each of these sensors may measure one or more physiological health data. Each of the sensors may measure health data at the same or different sampling frequencies and/or time periods, and the health data collected by these sensors may be processed using the same or different methods. Any existing or future sensors (e.g., ECG electrodes, accelerometers (including, e.g., 3-dimensional xyz activity monitors), sensors for pressure, sensors for impedance, thermometers, and any other biocompatible sensors) may be used for collecting health data.

The collected health data may be displayed or presented to a user (physician or other healthcare provider) in a report. The report may include multiple (two or more) health data displayed such that the user can quickly gain a good understanding of the patient's health. The health data may include sensor collected data and data calculated based on the collected data. In some embodiments, the displayed health data may include at least two health data, e.g., two, three, four, five, or more health data. The displayed health data may include, for example, two or more of average heart rate, activity level, respiration rate, blood pressure, pulse oximetry, impedance, and patient reported symptoms. In some embodiments, the report may include comments or observations from the user, and/or feedback from the patient, such as reported symptoms or confirmation of medication taken at prescribed times.

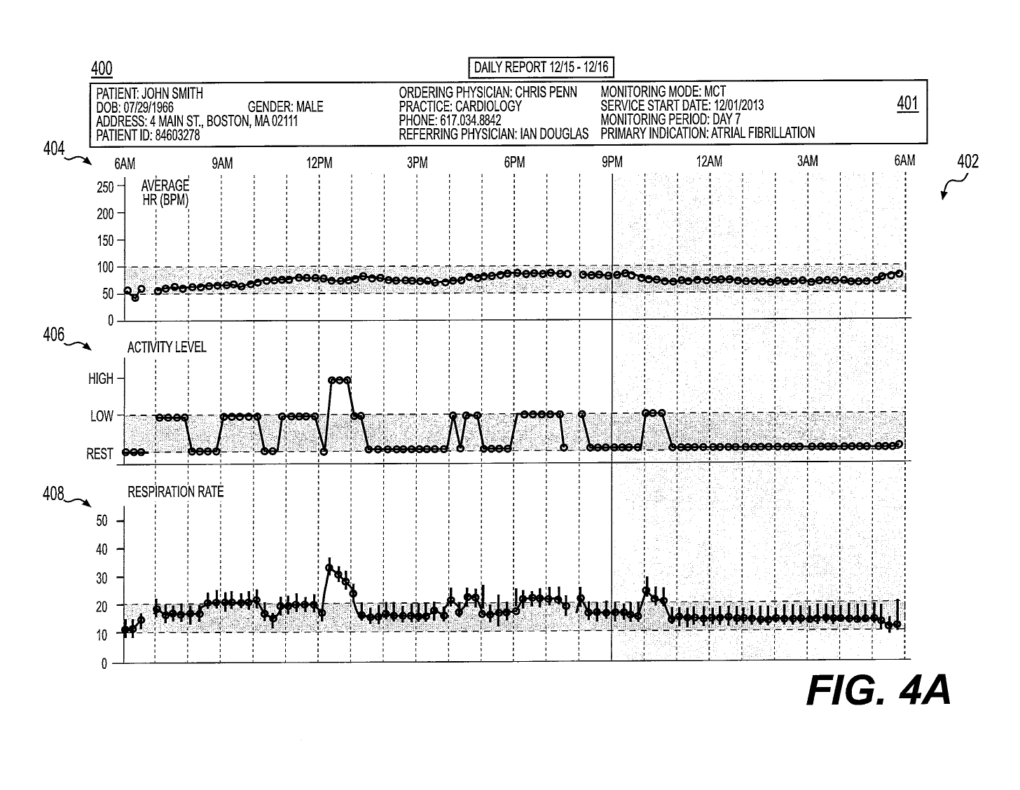

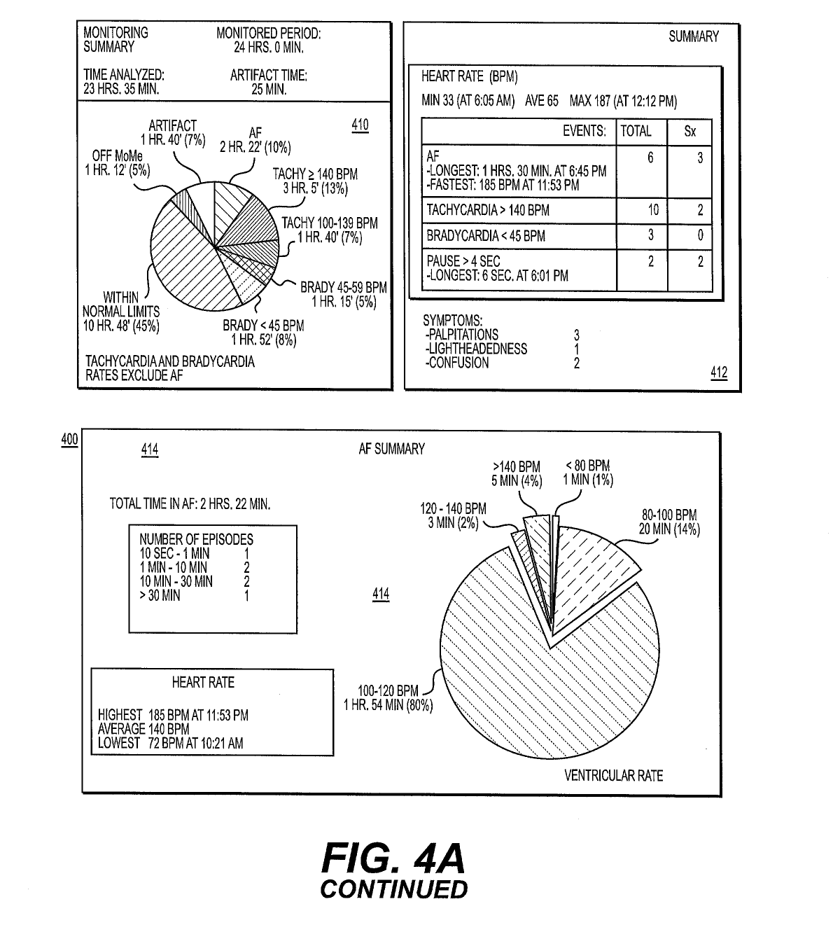

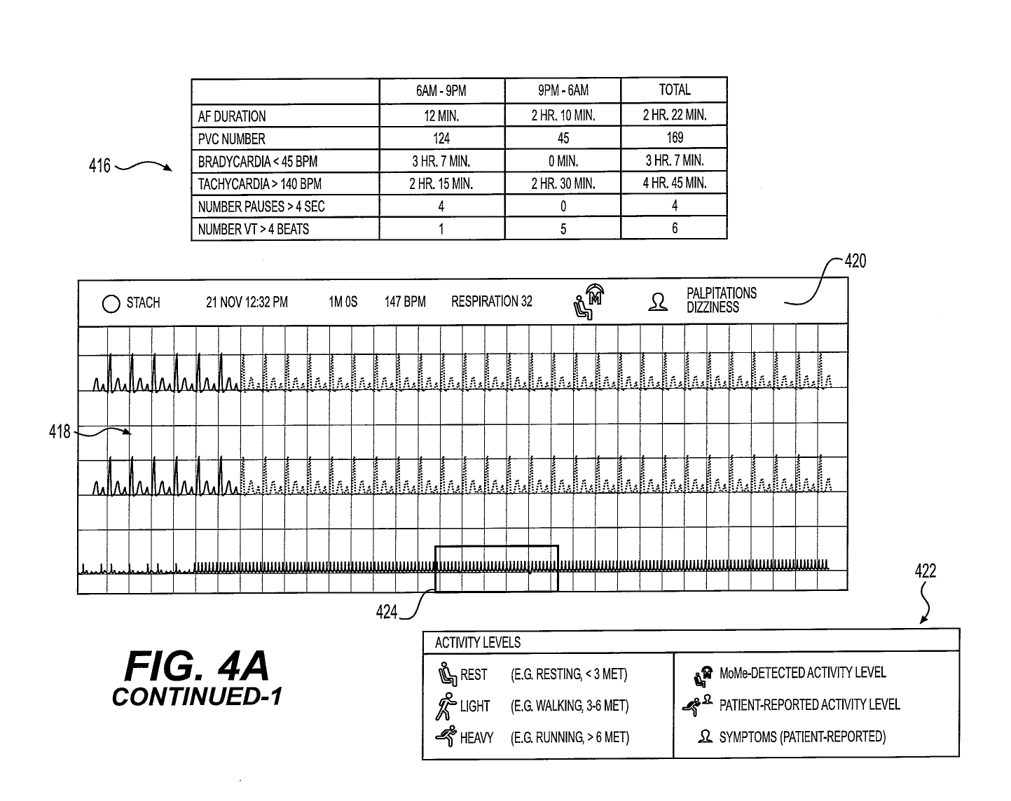

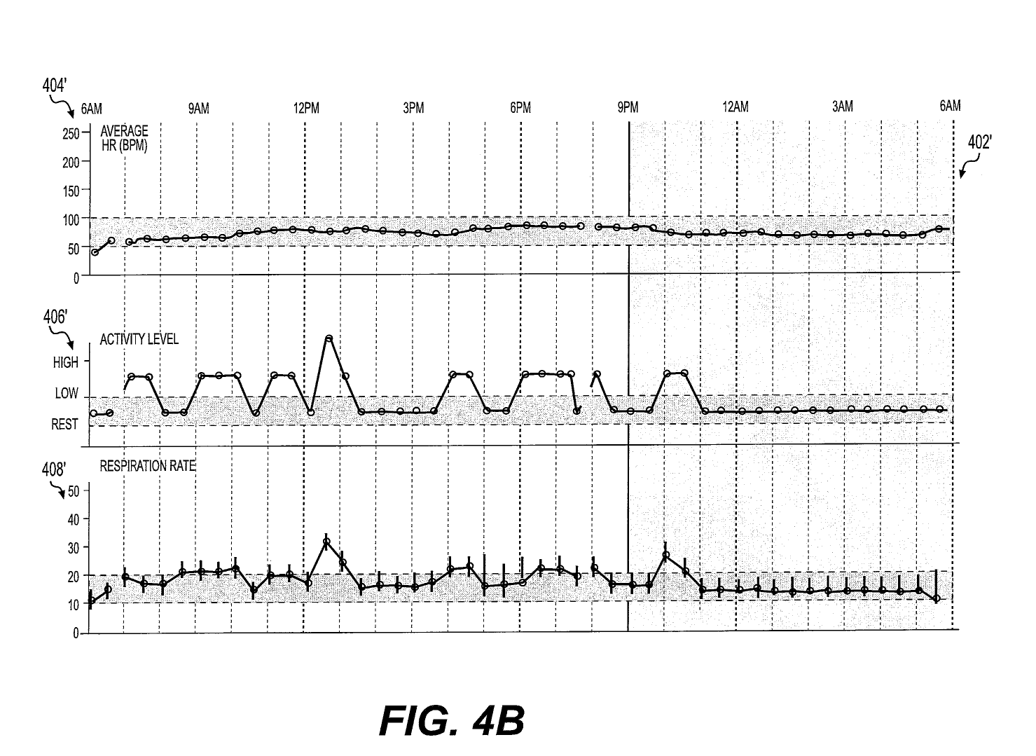

FIG. 4A illustrates an exemplary patient report 400 of a patient for a 24 hour time period (e.g., 6 a.m. to 6 a.m.). As shown in FIG. 4A, report 400 may include a biographical section 401 with information related to the patient and the health care professionals associated with the patient. Among other information, the biographical section 401 may include the name, gender, age, address, and other relevant details of the patient. The biographical section 401 may also include the name and contact information of the health care professionals associated with the patient (e.g., the physician who ordered the data monitoring and the physician who referred the patient). The information in the biographical section 401 may be entered by the patient, the user, another technician, or may be retrieved from medical records. Biographical section 401 may also list the relevant data collection parameters (e.g., the monitoring mode and date, reason, etc.). It should be noted that the biographical section 401 illustrated in FIG. 4A is only exemplary. In general the biographical section 401 of a report 400 may include any relevant information that may assist the user viewing the report and/or for cataloging the report.

Report 400 may also include a graph or a time series representation (time series 402) showing the variation of the presented health data over time. As described previously, the presented health data may include both detected/measured data and parameters calculated based on the measured data. Time series 402 may plot the value of the presented health data for any period of time (1 hr, 12 hrs, 24 hrs, 2 days, 1 week, etc.). FIG. 4A illustrates a time series 402 showing the variation of three health data (average heart rate 404, activity level 406, and respiration rate 408) over a 24 hour time period. The y-axis of each health data set may indicate the value of the data set in the appropriate units, and the x-axis may indicate time units. For example, the y-axis of each of the average heart rate 404, the activity level 406, and the respiration rate 408 may be indicated in the appropriate units for these parameters, and the x-axis of each of the health data sets may be time. In some embodiments, the y-axis of average heart rate 404 may be indicated in beats per minute (bpm) and the y-axis of respiratory rate 408 may be indicated in breaths per minute. In some embodiments, the y-axis of activity level 406 may be presented in categorical units, e.g., rest, low activity, or high activity. A legend 422 may be displayed in the report 400 to assist the user in understanding the categorical units.

In some embodiments, the user may change the y-axis scaling of the time series 402. The y-axis scaling may be changed separately for each health data set or may be changed together for all the data sets. The scaling may be changed in any manner. In some embodiments, the user may enter (e.g., into a text box) the desired minimum and maximum y-axis values for a health data set. In some embodiments, the user may pick (e.g., using a cursor) values on the y-axis to be used as the minimum and maximum values. For example, in a health data graph of time series 402 having a y-axis between 0 and 20, the user may rescale the graph to have a y-axis between 5 and 10 by clicking on the Y-axis locations of 5 and 10. In some embodiments, a health data set may also be normalized using any y-axis value.

In some embodiments, the y-axis of a health data curve may indicate the normal range (or one or more normal ranges) for that health data. A normal range may indicate a range of the health data values that is considered to be normal for a patient. This normal range may be indicated in any matter. In some embodiments, the normal range indicator may include a shaded or a colored bar (or box) that is overlaid on a health data graph to facilitate identification of values outside the normal range. For example, as illustrated in the average heart rate 404 graph of FIG. 4A, a shaded horizontal bar may be used to indicate a normal heart rate range of 50-100 bpm. Alternatively or additionally, in some embodiments, a health data graph may include an indicator to highlight regions (or values) that are outside the normal range. For example, in some embodiments, the average heart rate 404 graph may include a shaded or a colored box (or any other indicator) to highlight values of heart rate above 100 bpm and/or below 50 bpm. In some embodiments, the data points on some or all of the health data graphs may be colored to distinguish between values that are normal and values that are abnormal (e.g., above and/or below normal). For example, in some embodiments, the data points of the average heart rate 404 graph that are between 50-100 bpm may be colored blue, the data points that are above 100 bpm may be colored red, and the data points that are below 50 ppm may be colored green (or red).

The normal range identified in a health data graph may be a range that is considered to be normal for all patients, or it may be a range that is considered to be normal for a particular patient. For instance, based on a patient's individual history (medical history, physical fitness, etc.), a patient may have a normal heart rate range lower (or higher) than a range that is commonly associated as being normal. In some embodiments, the report may allow the user to select or change the normal range associated with one or more of the heath data graphs of a time series 402. A data point that is outside of the normal range would be identified as abnormal for the patient. In some embodiments, a report 400 may include a feature to highlight a health data point (or set an alert) when a health data exceeds a threshold value. For example, the user may indicate a threshold value (or range) for a health data (e.g., respiration rate), and values of the health data that exceed this threshold value (or are outside the range) may be highlighted (by another color, by a shaded region, etc.). In some embodiments, one or more of the health data sets (average heart rate 404, activity level 406, and/or respiration rate 408) may indicate the maximum, minimum, and average value of a measurement. For example, a vertical line through each data point in respiration rate measurements 408 of FIG. 4A indicates the maximum measured value, the minimum measured value, and the average measured value.

The multiple health data graphs of the time series 402 may indicate time averaged values of the health data. For example, values of average heart rate 404, activity level 406, and respiration rate 408 plotted in time series 402 of FIG. 4A is data averaged over 15 minute time intervals. The 15 minute time interval used for data averaging is only exemplary. In general, any time interval may be used for data averaging. For example, FIG. 4B illustrates a time series 402′ in which the average heart rate 404′, activity level 406′, and respiration rate 408′ data is averaged over 30 minute time intervals. Other embodiments of reports may include a time series showing health data averaged over different time intervals (e.g., beat to beat averages, 5 minute averages, 1 hour averages, etc.). It is also contemplated that in some embodiments, the time series may include unaveraged values of the health data (e.g., data at particular points in time).

Although each of the multiple health data illustrated in FIG. 4A is averaged over the same time interval (i.e., 15 mins), this is only exemplary. In some embodiments, a single report may include health data averaged over different time intervals. For example, the average heart rate 404 and the activity level 406 may be averaged over 15 minute time intervals and the respiration rate 408 may be averaged over 30 minute time intervals. In some embodiments, the time interval for averaging may be a user selected value. For example, in an exemplary embodiment, a report 400 may be displayed with a time series 402 averaged over a default value of time interval (e.g., average heart rate 404, activity level 406, and respiration rate 408 each averaged over 15 minute time intervals). The report 400 may then allow the user to select a different averaging time interval for each (or all) of the health data. If a different value is chosen by the user, then a new report with the time series 402 calculated using the selected value of time interval may be displayed.

In a report 400, the health data sets presented in a time series 402 (e.g., average heart rate 404, activity level 406, and respiration rate 408) may be aligned temporally (e.g., along the x-axis) such that any vertical line intersecting the data sets may indicate the same point in time. For example, in time series 402 of report 400 (FIG. 4A), a vertical line at 12 PM (marked by a dashed line) indicates the average heart rate 404, the activity level 406, and the respiration rate 408 of the patient at 12 PM. Aligning and displaying the health data in this manner may facilitate quick analysis and patient evaluation and/or diagnosis. For example, a user analyzing report 400 may quickly and easily check the patient's activity level and heart rate (and other health data that are included in time series 402) corresponding to the patient's abnormal respiration rate between about 12:30-1:00 PM. In general, temporally aligning the health data sets along an axis, may assist the user in quickly analyzing each parameter within the context of the other parameters to identify time-correlated health events or trends. Although FIGS. 4A and 4B illustrate the health data curves temporally aligned along the x-axis, this is only exemplary. In some embodiments, the health data curves may be arranged such that the curves are temporally aligned along the y-axis. In such embodiments, the y-axis of the curves may indicate time, and the curves may be arranged such that a horizontal line intersecting the data sets may represent data at the same point in time.

Time series 402 of a report 400 may include an indicator (e.g., a line) that distinguishes between night and day (or the time period when the patient is sleeping from the time period when the patient is awake). In some embodiments, indicators at fixed times (e.g., 9 PM and 6 AM) may differentiate between day and night. For example, the time period between 9 PM and 6 AM may be considered night time or the time period when the patient is sleeping. In some embodiments, these indicators may be based on patient feedback. For example, in some embodiments, the patient may indicate (for e.g., by pressing a button) when the patient goes to bed and when he/she wakes up. In some embodiments, this information may be derived based on other patient input (e.g., based on when the patient reports taking a medicine, etc.). And, indicators may be located on the time series 402 based on the patient provided input.

In some embodiments, night time or the patient's sleep time in time series 402 may be shaded (or otherwise marked) to aid the user in distinguishing health data recorded during the day from those recorded during the night. This feature may further allow the user to analyze and identify health-related events or trends within the context of a patient's diurnal cycle, such as correlation of sleep apnea with any irregular health measurements such as arrhythmias. The classification of day and night may be adjusted according to the diurnal cycle of a particular patient.

Time series 402 of a report 400 may include also include one or more indicators that record the times at which specified events occur. The events for which the indicators are included may be specified by the user. In some embodiments, indicators may record the times at which the patient takes a medicine. For example, the patient may press a button associated with a health monitoring system to indicate when he/she takes a medicine. Time series 402 may then highlight the time at which it receives this patient notification. In some embodiments, the indications may highlight patient reported symptoms. For example, if at 9 AM the patient reports experiencing discomfort (e.g., dizziness), time series 402 may include an indicator that highlights to the user the patient reported symptom. These indicators may be located at the corresponding time in any or all of the graphs of time series 402, or may be separately indicated (e.g., on a pop-up window, etc.).

While FIGS. 4A and 4B show health data collected over 24 hours, shorter time periods (e.g., 1 hour, 2 hours, 6 hours, 12 hours, 18 hours) or longer time periods (e.g., 2 days, 5 days, 10 days, 30 days) may also be displayed in a report 400. Further, in some embodiments, health data collected in real-time may be displayed in a time series 402. In some embodiments, health data collected during an immediately preceding time period, such as the previous 24 hours or previous 48 hours, may be displayed (e.g., in a Daily or Up to Date Report). In some embodiments, once a data monitoring service has ended, all of the health data collected may be displayed in an End of Service Report. In some embodiments, the time series 402 may include annotations for particular data points or ranges of data. These annotations may include comments (such as, observations, diagnoses, etc.) by a user and symptoms reported by the patient. In some embodiments, these annotations may be displayed (e.g., in a text box) on the report, and in other embodiments markers (or other icons) may indicate that presence of an annotation at a location. Clicking (or otherwise selecting) on a marker may then display the annotation (e.g., in a pop-up window). In some embodiments, these annotations may be oriented to indicate that the comment is related to data corresponding to a particular time period.

In some embodiments, report 400 may also include one or more data summary sections. The summary sections may list statistical information (e.g., average, maximum, and/or minimum values) of the health data presented in a report 400. This information may be presented in any manner (diagrams, illustrations, tables, or other descriptive representations) to present the data in a meaningful way. In some embodiments, a summary section may summarize the total time (or the percentage of time) the patient was out of normal range for some or all of the health data. In some embodiments, the summary section may separately summarize the time outside normal range during day time and night time (or any other selected time period). In some embodiments, patient reported data (such as, symptoms (dizziness, etc.) and information (medicine taken, etc.)) may also be included in the summary section. In some embodiments, the summary sections may include one or more of monitoring summary 410, heart rate summary 412, atrial fibrillation (AF) summary 414, and diurnal summary 416. These summary sections may provide a snapshot of the data collected over a time period. In some embodiments, some or all of the summary sections may automatically be included with the report 400. In other embodiments, the user may select the summary sections that are desired to be displayed. For example, in some embodiments, icons (or buttons) may indicate the presence of a summary section. And, clicking an icon (e.g., monitoring summary icon, AF summary icon, etc.) may expand a summary section.

In some embodiments, a summary section may indicate the amount of time a particular health event occurred, or the time period for which a range of health data values was recorded. For example, monitoring summary 410 may include a pie chart to show different types of events recorded over the 24-hour time period, and AF summary 414 may include a pie chart dividing the total time in which an atrial fibrillation event was recorded by ventricular rate/heart rate. Summary sections may also compare the number of events that occurred during the day to those that occurred during the night. For example, diurnal summary 416 compares the number of health related events and/or duration of the events (e.g., AF duration, premature ventricular contraction (PVC), bradycardia, tachycardia, pauses >4 seconds, and number of ventricular tachycardia events >4 beats) recorded during the day to those recorded during the night.

The summary sections may also include comments, observations, conclusions, diagnoses, etc. by a user and/or patient feedback. In some embodiments, these comments may appear as notes that are typed in by the patient and/or the physician. Alternatively or additionally, in some embodiments, these comments may record instances of an event reported by the patient and feedback from the physician. For example, the heart rate summary 412 of FIG. 4A indicates the number of incidents of palpitations, lightheadedness, and confusion reported by the patient. This section may also indicate the number of events (e.g., AF, tachycardia, bradycardia, and pauses >4 seconds) of the total that were symptomatic (Sx) as opposed to non-symptomatic events. A summary section may also include the “out of range” data that indicates measurements that are out of the selected range in time series 402.

Patient reports 400 and displays of health data according to the present disclosure also may include one or more raw data, pre-processed data, and/or partially processed data 418. This data may be presented in any manner. In some embodiments, this data 418 may be presented as a graph. For example, report 400 of FIG. 4A presents ECG data 418 in the form of a graph. In some embodiments, the data 418 may include an information section 420 that indicates details or information pertaining to the presented data. For example, information section 420 of the ECG data 418 indicates the date of the measurements and relevant health related information (e.g., heart rate, respiration rate, patient activity level, etc.) of the patient. In some embodiments, patient-recorded symptoms corresponding to a particular time or time period may also be indicated in the information section 420. The information section 420 may include text, descriptive representations, or a combination thereof to annotate data recorded during the particular time or time period. A legend 422 may define or further explain the text and/or representations shown in the information section 420. A window 424 may indicate the particular time or time period corresponding to the information presented in the information section 420. In some embodiments, the user may move the window 424 to a different location by, for example, clicking on the window 424 and moving it to the new location. In some embodiments, a user may also change the size of the window 424 by clicking and dragging a boundary of the window 424 to expand or contract it. If the window 424 is moved or resized, the information section 420 (or report 400) may update to indicate information related to the data in the new location. In some embodiments, as shown in FIG. 4A, the information section 420 may take the form of a strip located on the top portion of the data 418.

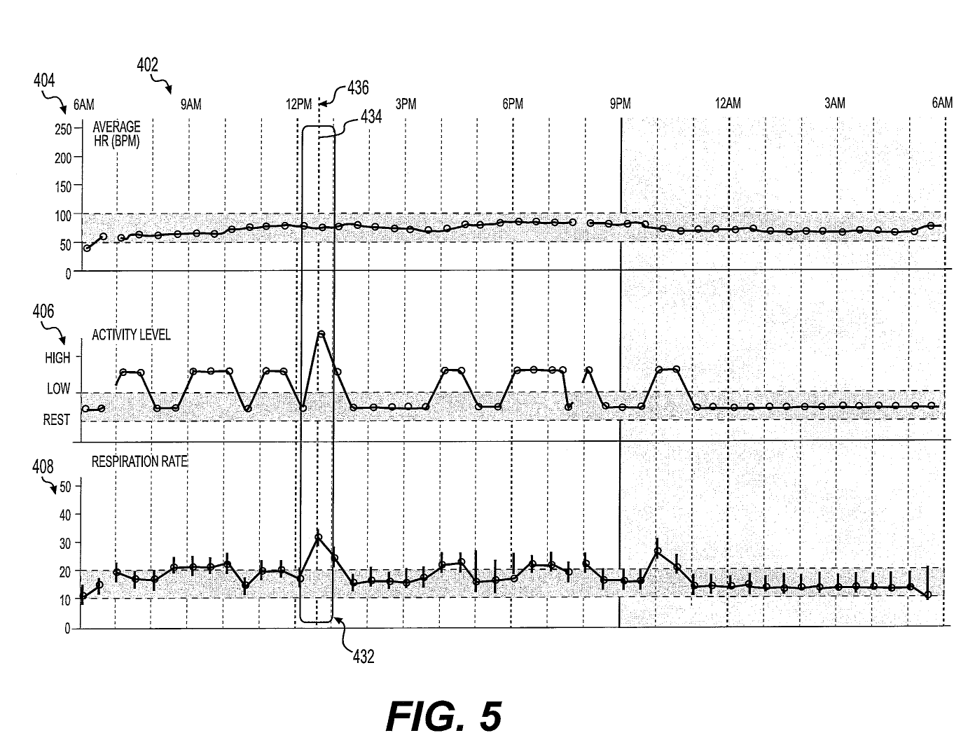

In some embodiments, the report 400 may include features that enable the user to view health data of a patient corresponding to a particular time or period. In some embodiments, by using these features, the health data and/or other information presented in the report 400 (and other health data) may be represented in a different manner. In some embodiments, the user may select a time point (or a time window) in the time series 402 to get health data associated with the selected time point. A time point may be selected in any manner. FIG. 5 illustrates an exemplary time series 402 that enables a user to select a desired time point (or time window) from the graph. A scroll bar 432 in time series 402 may allow the user to select a time point. The scroll bar 432 may have any shape and configuration. In some embodiments, the scroll bar 432 may include an outer box with a center line 434 (indicated as a dashed line). The scroll bar 432 may be dragged across the time series 402 to position the center line 434 at any x-axis (time) location to select a time point 436. In some embodiments, the time point 436 may be selected by positioning the center line 434 at the desired time point and clicking a button (an icon, or the screen). It should be noted that selecting the time point 436 using the scroll bar 432 is only exemplary. In general, any known method may be used (e.g., by using a cursor) to select the time point 436. Selecting the time point 436 may display health data associated with that time point.

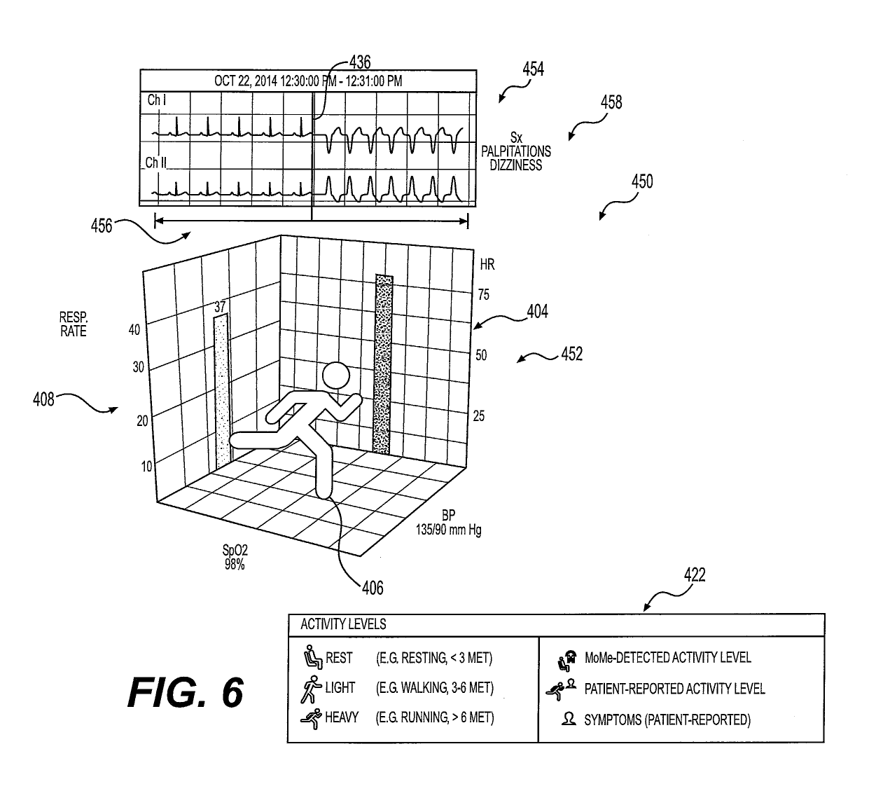

The health data associated with the time point 436 may be displayed in any manner. In some embodiments, selecting the time point 436 may open a pop-up window or a box with the health data associated with the time point 436. In some embodiments, this health data may be presented in a tabular form, and in other embodiments some or all of the health data may be presented graphically or pictorially. FIG. 6 illustrates an exemplary graphic display 450 of health data associated with a selected time point 436. For example, selecting time point 436 using the scroll bar 432 (or by any other method) may open a new window or a box in the existing window with display 450. Display 450 may include a multi-parameter three-dimensional graph 452 that shows some or all of the health data associated with the selected time point 436. In some embodiments, in addition to the health data (at time point 436) included in time series 402 (i.e., average heart rate 404, the respiration rate 408, and activity level 406), display 450 may also include health data that are not shown in time series 402 (e.g., oxygen saturation in blood (SpO2) and blood pressure (BP), temperature, etc. at time point 436). In some embodiments, some of the health data (such as, for example, activity level 406) may be represented using an icon described in legend 422.

In some embodiments, display 450 may also include data such as ECG data 454 at a time period 456 that encompasses the selected time point 436. The time period 456 may be selected by the user or may be preprogrammed into the system. In some embodiments, the display 450 may initially use a default preprogrammed time period which may be changed by the user. Display 450 may also include comments 458 (provided by the patient and/or the user) that are associated with the selected time point 436 or time period 456. In use, the user may select a time point 436 (in FIG. 5) that corresponds to a time of an abnormal reading of a health data (e.g., respiration rate 408 above the normal range) to get a comprehensive view of some or all the health data at that time point 436. Using this feature, the user may view an observed abnormal health data in the context of other health data obtained at the same time.

In some embodiments, instead of selecting a time point 436, the user may select a time period 456 from the time series 402 of FIG. 5. The selected time period 456 may correspond to the width of the box of the scroll bar 423 (see FIG. 5). The selected time period 456 may be changed by changing the width of the scroll bar box (e.g., by clicking and dragging the box to make it wider or narrower). In such embodiments, the health data shown in display 450 may be an average of the health data over the selected time period 456. For example, the respiration rate 408 shown in display 450 may be an average of the measured respiration rate over time period 456.

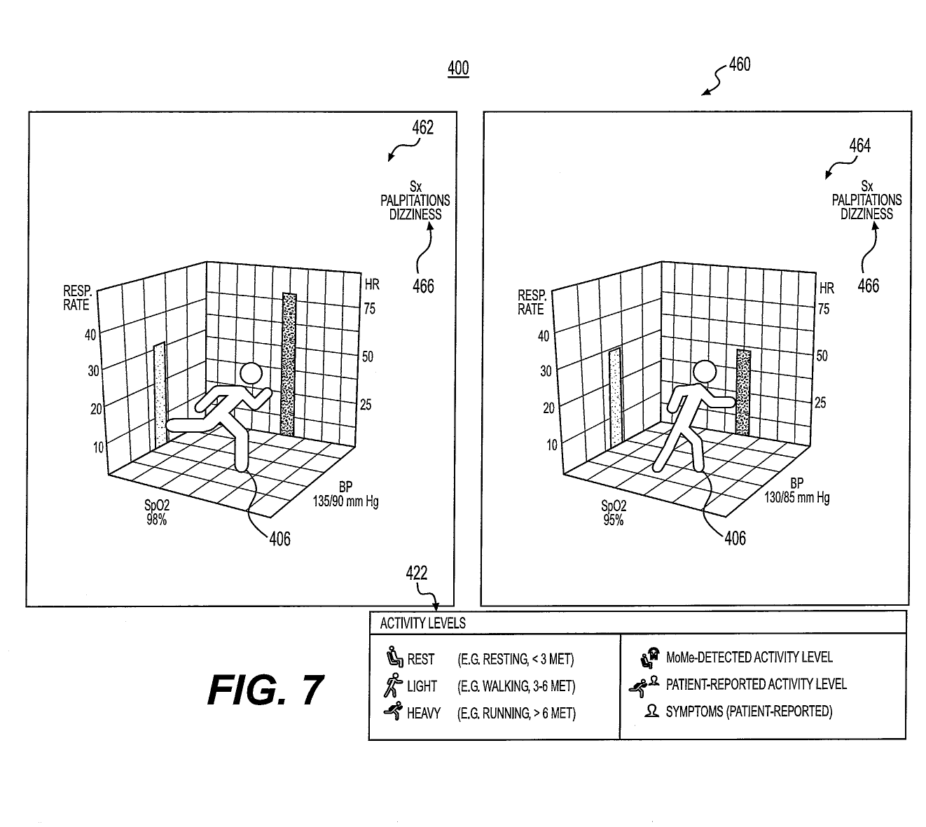

In some embodiments, report 400 may include a display that indicates the values of some or all of the health data corresponding to a time (or time period) when one of the monitored health data is abnormal. FIG. 7 illustrates an exemplary display 460 that indicates the status of several health data when one monitored health data is abnormal. Similar to display 450, display 460 may be shown in portion of the report 400 or may be shown in a pop-up window that opens in response to user selection (of, for e.g., an icon or a button). The exemplary display of FIG. 7 includes a first display 462 and a second display 464. First display 462 may show an average value of some or all of the health data during a time period when one health data (e.g., respiration rate 408) is abnormal. For example, if the monitored respiration rate 408 of the patient is abnormal between 12:15 PM and 12:30 PM (as observed in time series 402 of FIG. 4A), first display 462 may show average values of some or all of the health data (activity level 406, respiration rate 408, SpO2, BP, temperature, etc.) recorded between 12:15 PM and 12:30 PM. The user may activate the display of first display 462 in any manner. In some embodiments, tracing a window on the screen (e.g., using a cursor, using a finger in embodiments with touch sensitive screens, etc.) around desired data points (or time period) in the respiration rate 408 curve of time series 402 (of FIG. 4A) may activate the first display 462. In some embodiments, first display 462 may show averaged values of heath data over all (or several) time periods during which the respiration rate 408 (or another health data) is abnormal.

In some embodiments, the user may select a data point (or a time point) on the time series 402 (or FIG. 4A) to view all (or some of) the health data corresponding to the selected time point. For example, the user may wish to view all the monitored health data of the patient at an instant of time when one of the health data (e.g., average heart rate) is indicated as being abnormal in time series 402. In some embodiments, selecting (using the cursor, finger, etc.) the abnormal data point on the time series 402 (of FIG. 4A) may activate second display 464. Second display 464 may indicate the values of all (or some of) the monitored health data corresponding to the time of the abnormal heart rate. In some embodiments, display 460 may include an indication (listing, graphical, tabulated, etc.) all the instances when the heart rate (or another health data) is abnormal. For instance, when the user selects an abnormal heart rate data point on time series 402, the display 460 may include an indication of all the times (or time periods) when heart rate is abnormal, and the values of all (or some of) the health data at these times. In some embodiments, the number and type of health data shown in the first and second displays 462, 464 may depend upon the abnormal health data. For instance, the first and second displays 462, 464 may only show the health data that are related (i.e., the health data that may be affected by, or may cause the abnormal reading) to the abnormal health data. In some embodiments, first and second displays 462, 464 may also include comments 466 (provided by the patient and/or the user) that are associated with the selected time point or time period.

Although FIG. 7 illustrates only two displays (first display 462 and a second display 464), it should be noted that a different number (more or less) of displays may be present based on the number of health data that exceeds their normal range. It should also be noted that, although FIG. 7 illustrates the average health data as being displayed using a graphical representation similar to FIG. 6, this is only exemplary. In general, the average values of health may be displayed in any manner (tabulated, pictorially represented, etc.).

Patient reports 400 and displays of health data according to the present disclosure may be provided in written form and/or displayed electronically, such as on a graphical user interface, e.g., of a computer, tablet computer, smartphone, or other mobile device. The reports 400 may be displayed (or otherwise presented) in any language. In some embodiments, the user may select and/or change the language of the report 400. The user may interact with the health data (including the displayed and summarized health data) through the device, and use the interactive display to modify the display of data, and to make health-care related decisions (e.g., healthcare management, patient care, etc.) based on the displayed and reviewed patient health data.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

We claim:

1. A method for displaying health data, the method comprising:
receiving two or more health data sets, each health data set being physiological data of a patient as a function of time; and
generating a display of the two or more health data sets such that a first health data set of the two more health data sets is visually aligned with a second health data set of the two or more health data sets at multiple points in time.

2. The method of claim 1, wherein generating a display includes generating a display such that all health data sets of the two or more health data sets are visually aligned at all points in time.

3. The method of claim 1, wherein each health data set of the two or more health data sets is displayed in a graph extending along a horizontal time axis, with the graph of each data set being stacked along a vertical axis.

4. The method of claim 1, wherein the two or more health data sets include at least one of a cardiovascular parameter, a respiratory parameter, a cognitive parameter, a musculoskeletal parameter, a dermatological parameter, a vascular parameter, and a gastrointestinal parameter.

5. The method of claim 1, wherein the two or more health data sets include one or more of a heart rate, an activity level, a respiration rate, a blood pressure, a blood oxygen saturation level, a blood insulin level, a pulse oximetry value, an impedance value, and a body temperature.

6. The method of claim 1, wherein the generated display further includes comments from at least one of a physician, a healthcare provider, and the patient.

7. The method of claim 1, wherein generating a display includes generating a display of the two or more health data sets for a period of time of twenty-four hours.

8. The method of claim 1, wherein the generated display distinguishes a period of time corresponding to day time and a period of time corresponding to night time.

9. The method of claim 1, wherein the generated display includes an indicator that indicates a normal range of at least one data set of the one or more data sets.

10. The method of claim 9, wherein the indicator includes a bar extending parallel to a time axis.

11. A device for displaying health data of a patient, the device comprising:
a data storage device storing instructions for displaying health data;
a processor configured to execute the instructions to perform a method comprising:
receiving two or more health data sets, each health data set being physiological data of the patient as a function of time; and
generating a display of the two or more health data sets such that a first health data set of the two more health data sets is visually aligned with a second health data set of the two or more health data sets at multiple points in time.

12. The device of claim 11, wherein generating a display includes generating a display such that all health data sets of the two or more health data sets are visually aligned at all points in time.

13. The device of claim 11, wherein each health data set of the two or more health data sets is displayed in a graph extending along a horizontal time axis, with the graph of each data set being stacked along a vertical axis.

14. The device of claim 11, wherein the two or more health data sets include one or more of a heart rate, an activity level, a respiration rate, a blood pressure, a blood oxygen saturation level, a blood insulin level, a pulse oximetry value, an impedance value, and a body temperature.

15. The device of claim 11, wherein the generated display further includes comments from at least one of a physician, a healthcare provider, and the patient.

16. The device of claim 11, wherein the generated display includes an indicator that indicates a normal range of at least one data set of the one or more data sets.

17. The device of claim 11, wherein the generated display further includes information received from at least one of: a physician, a healthcare provider, or the patient.

18. A non-transitory computer readable medium comprising instructions that when executed on a processor cause the processor to perform operations comprising:
receiving two or more health data sets, each health data set being physiological data of the patient as a function of time; and
generating a display of the two or more health data sets such that a first health data set of the two more health data sets is visually aligned with a second health data set of the two or more health data sets at multiple points in time.

19. The non-transitory computer readable medium of claim 18, wherein generating a display includes generating a display such that all health data sets of the two or more health data sets are visually aligned at all points in time.

20. The non-transitory computer readable medium of claim 18, wherein each health data set of the two or more health data sets is displayed in a graph extending along a horizontal time axis, with the graph of each data set being stacked along a vertical axis.
